(19) United States
(12) Patent Application Publication
(10) Pub. No.: US 2026/0355979 A1
(43) Pub. Date: Nov. 12, 2026

(54) NEUROMORPHIC ROBOT ELECTRONIC SKIN

(71) Applicant: City University of Hong Kong, Hong Kong (HK)

(72) Inventors: Xinge YU, Hong Kong (HK); Yuyu GAO, Hong Kong (HK); Jianpeng ZHANG, Hong Kong (HK); Hehua ZHANG, Hong Kong (HK); Lung CHOW, Hong Kong (HK)

(21) Appl. No.: 19/670,040

(22) Filed: May 7, 2026

Related U.S. Application Data
(60) Provisional application No. 63/802,572, filed on May 8, 2025.

(51) Int. Cl. B25J 13/08; B25J 9/00

(52) U.S. Cl. CPC B25J 13/084; B25J 9/0009

(57) ABSTRACT

The present invention discloses a neuromorphic robotic electronic (NRE) skin configured to emulate biological tactile perception and reflex response. The NRE skin comprises a substrate, a circuit layer disposed on the substrate, a sensing layer disposed on the circuit layer, and a cover layer disposed on the sensing layer. The sensing layer includes an array of sensors configured to detect tactile stimuli at corresponding locations and convert the stimuli into electrical sensing signals. The circuit layer includes multiple pulse generators configured to encode stimulus magnitude and location into pulse signals, a signal integrator module configured to combine the pulse signals into an integrated pulse signal, and a label superimposing module configured to superimpose a characteristic pulse to generate a label pulse signal. A pain receptor generates a pain signal when the stimulus exceeds a threshold, and connectors transmit the label or pain signals to external processing or motion center.

### CROSS-REFERENCE TO RELATED APPLICATIONS

The present application claims priority from the U.S. Provisional Patent Application No. 63/802,572 filed 8 May 2025, and the disclosure of which is incorporated herein by reference in its entirety.

### FIELD OF THE INVENTION

The present invention generally relates to artificial skin. More specifically the present invention relates to a neuromorphic robot electronic (NRE) skin with active pain and injury sensing through bio-inspired neural impulse transmission.

### BACKGROUND OF THE INVENTION

With recent advancements in sensing technologies, visual and audio systems, and large language models, embodied intelligent humanoid robots have undergone substantial development. Modern humanoid robots are capable of walking, running, jumping, and performing fine-grained manipulation using articulated arms and fingers with a level of precision increasingly comparable to that of humans. In particular, progress in humanoid tactile perception has significantly enhanced robotic sensitivity, enabling the detection of subtle mechanical stimuli. As human skin constitutes the largest sensory organ of the body, its dense distribution of tactile receptors provides rich sensory information that supports not only basic motor control, but also higher-level functions such as emotional interaction, physical contact awareness, and self-protective response.

A common perception of robots is that they are inherently robust and capable of withstanding extreme operating conditions without damage. However, as robotic assistants are deployed in closer proximity to humans and operate within shared environments, the ability to perceive external stimuli from a human-centric perspective becomes increasingly important, including the capability to sense potentially harmful interactions. Existing robotic electronic skin systems typically provide basic functions such as pressure sensing and contact localization using conventional sensing schemes. These approaches generally lack an integrated architecture that combines sensing, signal processing, and distributed intelligence, and they do not support advanced capabilities such as active pain perception, injury detection, or localized reflex-like responses.

Conventional robotic electronic skin architectures commonly rely on grid-based or point-to-point wiring schemes, in which continuous analog signals are passively scanned at high frequency by a centralized control unit to determine touch location and intensity. By contrast, biological tactile systems operate using active neural signaling mechanisms. Human nerve endings generate discrete neural impulses that encode touch modality, spatial location, and stimulus intensity, which are transmitted through hierarchical neural pathways to the central nervous system. This hierarchical receptive field organization enables efficient encoding and transmission of tactile information, supporting rapid and adaptive responses to external stimuli.

Several early studies have investigated neuromorphic strategies for converting analog tactile signals into pulse-based representations for transmission. However, these approaches have primarily focused on signal conversion itself, while the rich temporal and dynamic information inherently embedded within the pulse characteristics has received limited attention. As a result, the potential for implementing advanced tactile functionalities based on such dynamic pulse information, including intelligent perception and localized response behaviors, remains largely unexplored.

### SUMMARY OF THE INVENTION

The present invention provides an electronic skin that not only provides fundamental tactile sensing but also offers advanced features like active pain and injury detection. Through an integrated approach including structure engineering, device architecture and system-level design, the electronic skin can seamlessly code dynamic information into the pulse trains and it incorporates a pain center capable of initiating protective reflex arcs, when exposed to extreme pressure, the skin triggers immediate motor response for self-protection. Furthermore, the active injury sensing and fast assembly design enables the rapid identification of damaged region and swift replacement of it with intact one. This human-centered perspective allows humanoid robots to operate more naturally and comfortably with people.

In accordance with a first aspect of the present invention, a neuromorphic robotic electronic (NRE) skin is provided. The NRE skin comprises: a substrate; a circuit layer deposited on the substrate; a sensing layer deposited on the circuit layer; and a cover layer deposited on the sensing layer. The sensing layer includes an array of sensors, each configured for sensing a tactile stimulus applied on a corresponding location on the NRE skin and converting the sensed stimulus to an electrical sensing signal. The circuit layer includes: a plurality of pulse generators, each configured to: receive an electrical sensing signal from a corresponding sensor in response to a tactile stimulus; and generate a pulse signal encoded with magnitude and location of the tactile stimulus; a signal integrator module configured to combine the pulse signals generated by the plurality of pulse generators to produce an integrated pulse signal; and a label superimposing module configured to superimpose a characteristic pulse signal on the integrated pulse signal to obtain a label pulse signal; a pain receptor configured to trigger a pain signal when the tactile stimulus exceeds a pain threshold; and a plurality of connectors configured to transmit the label pulse signal to a processing center or transmit the pain signal to a motion center.

In accordance with a second aspect of the present invention, a neuromorphic robotic electronic (NRE) skin system is provided. The system comprises a plurality of the neuromorphic robotic electronic (NRE) skins in accordance of the first aspect, a processing center and a motion center. The processing center is configured to: receive a plurality of label pulse signals from the NRE skins respectively; and demodulate each label pulse signal to determine magnitude and position of a tactile stimulus associated with the label pulse signal; and the motion center is configured to, in response to a pain signal, drive one or more corresponding joint motors to form a reflex arc.

By endowing the NRE-skin with active pain perception and injury sensing capabilities, the present invention substantially extends the functional scope of conventional electronic skin systems and improves their suitability for real-world robotic applications. Unlike passive tactile sensing approaches that merely detect contact forces or locations, the disclosed NRE-skin enables the robot to actively perceive potentially harmful stimuli and distinguish between benign interactions and damaging events. This capability supports timely protective actions, such as load redistribution, motion adjustment, or localized reflex responses, thereby reducing the risk of structural damage to robotic components and improving operational safety during human-robot interaction.

### BRIEF DESCRIPTION OF THE DRAWINGS

Embodiments of the invention are described in more details hereinafter with reference to the drawings, in which:

FIG. 1 illustrates a neuromorphic robot electronic-skin (NRE-skin) system in accordance with the present invention, featuring a hierarchical, neural-like receptive field structure for both fundamental pressure sensing and advanced functions like active pain and injury detection;

FIG. 2 illustrates an NRE-skin in accordance with one embodiment of the present invention;

FIG. 3 illustrates schematic structure of the pressure sensor in the NRE-skin;

FIG. 4 illustrates force-pulse frequency relationship of the pressure sensor, indicating sensor resolution reaching 10 mN;

FIG. 5 illustrates a circuit layer in accordance with one embodiment of the present invention;

FIG. 6 is schematic illustration of field configuration and pulse encoding methodology of the NRE-skin system;

FIG. 7 illustrates circuit diagram and operational principle of a pulse generator in the NRE-skin;

FIG. 8 illustrates signal transmission network structure inside the NRE-skin;

FIG. 9 shows resistance change-pressure relationship of the pressure sensor;

FIG. 10 shows how increasing pressure on the pressure sensor elevates the pulse frequency.

FIG. 11 illustrates how pulse width of the pulse signal is tuned by a pulse-width modulation resistor;

FIG. 12A illustrates pulse shape for various values of a pulse-shape modulation capacitor; and FIG. 12B illustrates first derivates of the pulse signals for various values of a pulse-shape modulation capacitor;

FIG. 13 illustrates a relationship between amplitude-modulation resistor and pulse amplitude;

FIG. 14 illustrates a relationship between the pulse width and the resistance of pressure sensor at a fixed pulse-width modulation resistor of 3 kΩ;

FIG. 15A shows optical image of the NRE-skin pressed by a finger; and FIG. 15B shows “mountain-like” pressure profile applied on the AR-skin, showing corresponding changes in frequency and pulse shape;

FIG. 16 shows a relationship between pulse frequency and the applied pressure;

FIG. 17 shows response of the NRE-skin to multiple points of contact;

FIG. 18 shows a circuit diagram of an artificial pain receptor in accordance with one embodiment of the present invention;

FIG. 19 shows unified pulses before transmission to the signal cache center;

FIG. 20 shows a circuit diagram of a monostable multivibrator in accordance with one embodiment of the present invention;

FIG. 21 illustrates a relationship between an external resistor R_ex of the monostable multivibrator and the resulting pulse width. The final design targets a 2 ms pulse width.

FIG. 22 illustrates the cache signal, the pain signal and normal spike signal of the artificial pain receptor;

FIG. 23 illustrates how heavy pressure triggers the pain signal, which persists briefly after the stimulus is removed;

FIG. 24 illustrates cache voltage signals under different pressure levels;

FIG. 25 illustrates relationship between time to trigger pain under different applied pressures;

FIG. 26 illustrates time to trigger pain at varying press speeds under the same load;

FIG. 27 illustrates variation in cache voltage under an external pressure (44 kPa, which is large enough to trigger the pain feeling) across different holding times;

FIG. 28 illustrates that threshold pressure to trigger pain can be tuned by adjusting the sensitivity of the pressure sensor;

FIG. 29 illustrates performance of the pressure sensor with different sensitivities;

FIG. 30 illustrates circuit diagram of an injury detection unit in accordance with one embodiment of the present invention;

FIG. 31 illustrates live pulses generated by the injury detection unit, allowing injuries to be identified by the absence of these pulses;

FIG. 32 illustrates a relationship of pulse period and live resistance;

FIG. 33 illustrates pulse signals of different frequencies at various live resistances;

FIGS. 34A and 34B illustrate photo and schematic diagram of the NRE-skins being cut; and FIG. 34C illustrates live pulse signals from individual NRE-skins, showing that no live pulse is detected in the injured (cut) part;

FIG. 35 illustrates connection interface of the NRE-skin system in accordance with one embodiment of the present invention;

FIG. 36 illustrates a circuit diagram of a label superimposing module of the NRE-skin;

FIG. 37 illustrates a pulse signal generated by the NRE-skin with characteristic pulse on the peak position of the pulse;

FIG. 38 illustrates a relationship of frequency of the characteristic pulse and value of characteristic resistance;

FIG. 39 illustrates signals transmitted from sensors in two adjacent connected skins S1 and S2 respectively;

FIG. 40 shows signals, denoted as signals A to D, transmitted from a pixel P1 of skin S1, a pixel P1 of skin S2, a pixel P2 of skin S1 and a pixel P3 of skin S2 respectively to the processing center;

FIG. 41 illustrates the hierarchy recognition network for stimulus localization of the NRE-skin;

FIGS. 42A to 42D illustrate output pulse signals of the four primary steps in pulse recognition process, respectively;

FIG. 43A illustrates effect of the unification process on first order gradient variance in signal measurement; and FIG. 43B illustrated effect of the unification process on the prediction accuracy;

FIG. 44 is an illustration of the pain sensing and the local reflex arc;

FIG. 45 illustrates expression feedback by a humanoid robot subjected to different stress levels;

FIG. 46 is an illustration of active skin injury sensing; and

FIG. 47 illustrates expression feedback by a humanoid robot subjected to different injury conditions.

### DETAILED DESCRIPTION

Embodiments of the invention are described in more details hereinafter with reference to the drawings. In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

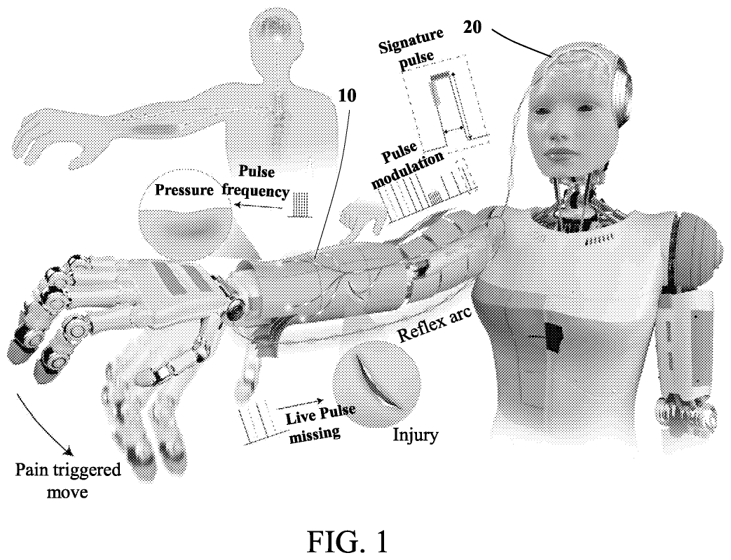

FIG. 1 illustrates a neuromorphic robot electronic-skin (NRE-skin) system featuring a hierarchical, neural-like receptive field structure for both fundamental pressure sensing and advanced functions like active pain and injury detection. The NRE-skin system comprises a plurality of NRE-skins 10 and central processing center 20. The NRE-skin system is designed to convert external tactile information, including intensity (resolution of 10 mN) and location details, into pulse trains. Leveraging its hierarchical receptive field structure, signals from each pixel (or channel) undergo progressive dimensionality reduction while retaining key features at each stage.

Ultimately, all these signals are consolidated into a single transmission channel for active delivery to the processing center. Additionally, the NRE-skin integrates an active pain-sensing center, autonomously responding excessive stimulus and triggering local motor reactions akin to a human reflex arc. It also supports active wound detection, identifying injury location and providing continuous alerts for self-inspection. The quick-release structural and circuit design allow rapid replacement of damaged regions. Altogether, this NRE-skin endows robots with human-like tactile capabilities, accelerating their development into empathetic and effective household assistants.

Functionally, human skin mainly comprises four layers: the stratum corneum, epidermis, dermis and subcutaneous tissue. Within the epidermis and dermis, multi-mechanoreceptor, and the hierarchy neural receptive field form an integrated information network. This network enables humans to discern both the intensity and location of external stimuli, encompassing both basic and advanced stimuli. Basic low-level stimuli are processed by peripheral neurons, forming reflex arcs that rapidly trigger response reactions (for example, pain perception). More detailed and advanced tactile information-such as of stimulus degree, precise position, and injuries detection-is conveyed to the brain for high level processing.

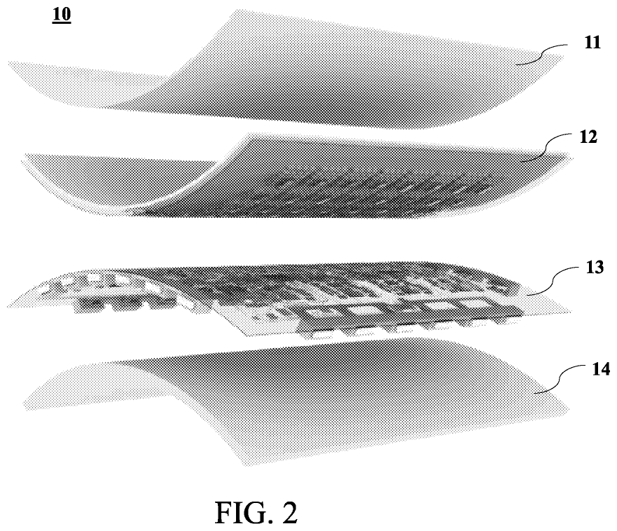

FIG. 2 illustrates an NRE-skin 10 in accordance with one embodiment of the present invention. As shown, the NRE-skin 10 comprises four layers: cover layer 11, sensing layer 12, circuit layer 13 and the substrate 14. The cover layer 11 mimics the stratum corneum for protection, while the substrate 14 mimics the skin's substrate, serving as a buffer against force impacts. The sensing layer 12 and the circuit layer 13 mirror human mechanoreceptors and transmitting nerves respectively. The sensing layer 12 and the circuit layer 13 form an artificial receptive field network. The sensing layer 12 transforms stimuli applied on the NRE-skin into pressure signals. The circuit layer 13 converts the pressure signal into pulse trains, which are then transmitted to a processing center. In one embodiment, the processing center may be an external device implemented separately from the NRE-skin. The circuit layer forms the core of the NRE-skin, functioning much like the nervous system in biological organisms.

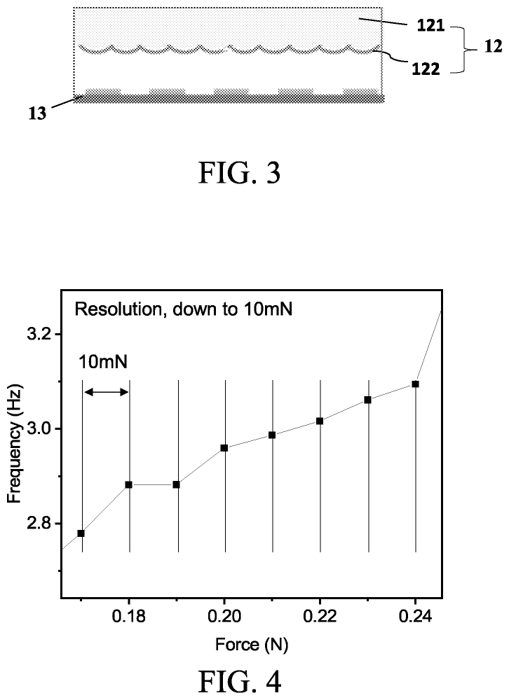

Preferably, the cover layer 11 and the substate 14 are made of flexible and biocompatible materials such as PDMS. The sensing layer 12 includes: a microstructured PDMS-based pressure sensing layer 121 spray-coated with a PEDOT:PSS layer 122 to constitute a pressure sensor. The circuit layer 13 includes a thermoplastic polyurethane (TPU) layer, a PI film and a copper electrode layer deposited on the PI film and configured to connect the pressure sensor to underlying electronic circuits on the circuit layer 13 (FIG. 3). This integrated sensor shows good performance and achieves a resolution of up to 10 mN (FIG. 4). Because all the layers are made of flexible materials, the integrated skin system shows excellent flexibility. The NRE-skin can stand with deformation like twisting and bending, ensuring the NRE-skin can conform to a robot's surface curvature.

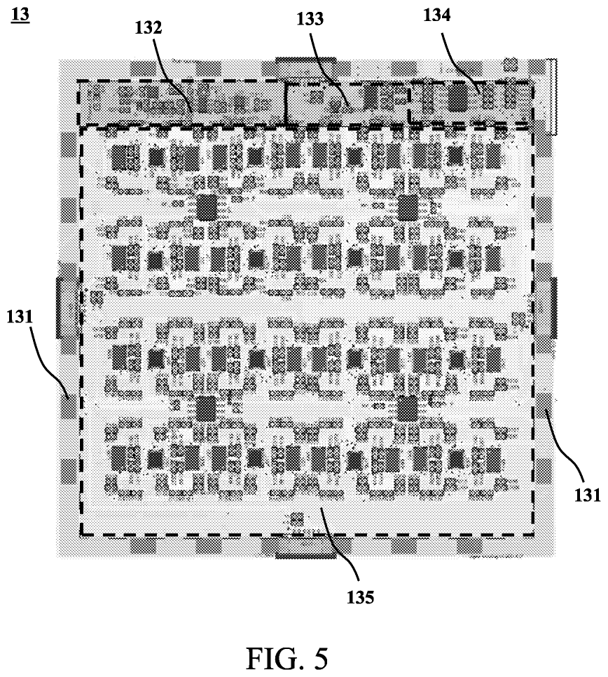

As seen in FIG. 5, the circuit layer 13 is divided into five distinct functional units: connector 131, pain center 132, label superimposing module 133, signal integrator 134 and pulse generation center 135. The connector 131 include connection electrodes distributed on edges of surrounding area of the circuit layer, which are configured to share the power and the signal with adjacent skin system. The pain center 132 reacts to excessive pressure by generating pain signals which can directly drive joint motors and form a basic reflex arc. The “label superimposing module” 134 modulates a sensing pulse signal with specific signaling features to distinguish the skin from other surrounding skin. The pulse generation center 134 matches with the pressure sensing layer 121 in the sensing layer and produces pulse trains of frequencies depending on the applied pressure. And finally, a “signal integrator” merges all the signals and output them collectively.

Biological neural systems employ a hierarchical structure that relays sensory signals from peripheral nerve endings through progressively higher-level processing centers. This layered design ensures that raw stimulus data, initially captured by localized receptive fields, undergo continuous refinement and converge into coherent perceptual layer by layer before reaching the brain to form coherent perception.

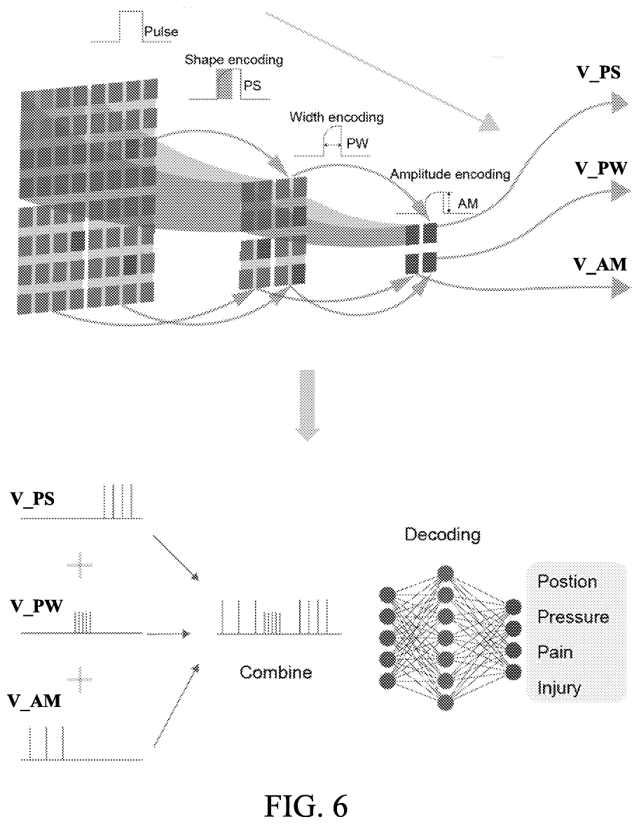

In order to emulate the sensing mechanism of biological skin, the sensing layer of the NRE-skin includes a two-dimensional array (e.g., 8×8) of tactile sensing units cooperating with the processing center based on a multi-layer hierarchical coding mechanism (FIG. 6). Each tactile sensing unit include a pressure sensor in the sensing layer, paired with a corresponding pulse generator in the pulse generation center, cooperating to convert an external stimulus into pulse signal where pulse frequency reflects stimulus intensity. The corresponding pulse generator is further configured to modulate the pulse signal with respect to certain spike characteristics (e.g. pulse shape, pulse width and amplitude) such that pulse signal has a distinct label which can be used for locating the stimulus. Finally, the modulated signals are converged (or combined) by the signal integrator and output to the processing center. By analyzing the spike characteristics, the processing center determines both the precise location and the intensity of the stimulus. This design provides the NRE-skin with basic edge-processing capabilities which significantly reduce its wiring complexity.

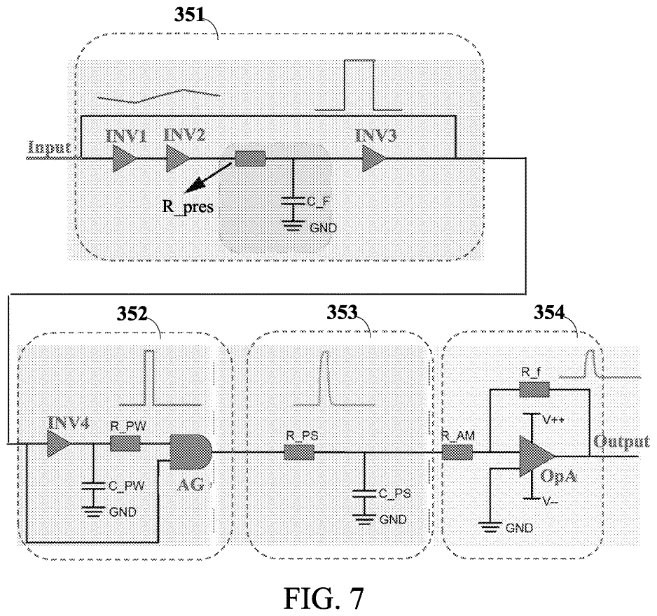

FIG. 7 illustrates a simplified circuit diagram of a pulse generator. As shown, the pulse generator includes a fundamental oscillation unit 351, a pulse width modulation unit 352, a pulse shape modulation unit 353 and a pulse amplitude modulation unit 354. The pulse width modulation unit 352, pulse shape modulation unit 353 and pulse amplitude modulation unit 354 together construct a hierarchical signal transmitting network (or artificial receptive field network) configured to generate a progressively modulated pulse signal with specific characteristics (pulse width, pulse width, and pulse amplitude) so that it has a distinct label identifiable by the processing center after propagating through different skins.

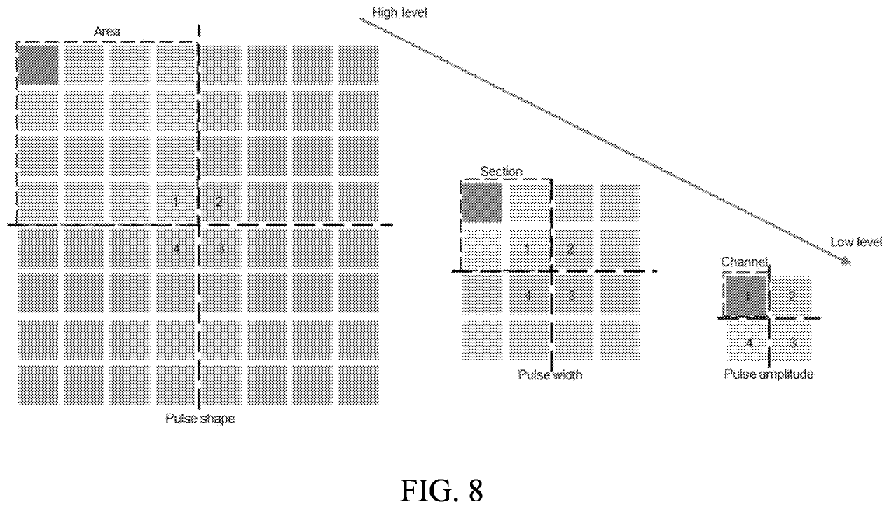

More specifically, when a pulse signal is generated, its characteristics are modulated according to its spatial location. For example, as shown in FIG. 8, the pulse signal generated in Area 1 all adopt a specific pulse shape pattern. Additionally, this pixel resides in Section 1, where the pulse width is further adjusted to a predefined value. Moreover, since the pixel is part of Channel 1, its amplitude is modified according to a predetermined setting. By analyzing these pulse characteristics layer by layer, each pixel's precise position can be accurately determined, from area to section to channel. Furthermore, for some special cases, this design enables rapid localization by analyzing only high-level pulse features (e.g. only inferring the signal area from the pulse shape). This approach provides approximate locations, facilitating human-like fuzzy recognition.

The fundamental oscillation unit 351 has a ring oscillator and a fundamental oscillation resistor-capacitor circuit (RC) circuit. The fundamental oscillation RC circuit includes a fundamental oscillation capacitor C_F and a custom designed piezoresistive pressure sensor acting as a resistor R_pres.

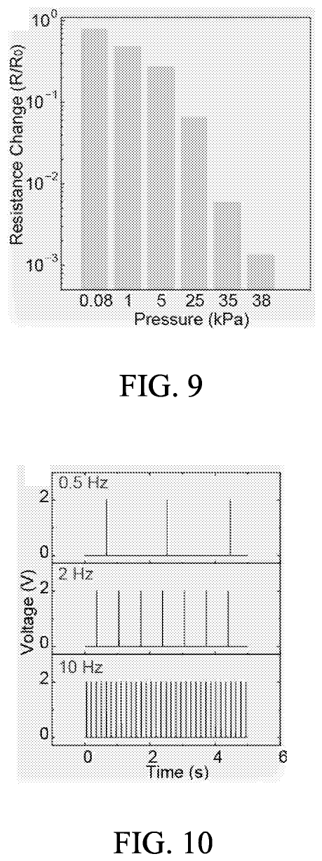

When external pressure is applied, the sensor's resistance decreases proportionally to the force, thereby reducing the time constant of the fundamental oscillation RC circuit, resulting increasing the pulse frequency (FIG. 9 and FIG. 10).

The ring oscillator is formed by an odd number of inverters (e.g. three inverters denoted as INV1, INV2 and INV3 respectively) and its oscillating period, T, can be represented by:

T=2×N×t_{d},
where N is the number of the inverters (must be an odd number) in the ring, t_{d} represents the propagation delay of each invertor.

From this, the operation frequency, f, is given by:

$$f = \frac{1}{T} = \frac{1}{2 \times N \times {t}_{d}} ,$$

Typically, the intrinsic period of a ring oscillator is on the order of nano seconds, resulting in frequency reach into the MHz range, which is far beyond most biological domains. To relate the external stimulus to the output, an RC delay circuit is inserted between the inverters in the ring oscillator. The fundamental period of an RC circuit is given by:

$${T}_{RC} = \frac{1}{{f}_{0}} = 2 π RC$$

It is clear that T_{RC} could be tuned by the R and C. In this work, the R is replaced by the piezoresistive-based pressure sensor (Rₚᵣₑₛ), whose resistance is inversely proportional to the applied external pressure. Consequently, the overall oscillation period of the combined system is

T=2×N×t_{d}+2πRₚᵣₑₛC

Correspondingly, the working frequency is:

$$f = \frac{1}{2 \times N \times {t}_{d} + 2 π {R}_{pres} C}$$

Since the 2πRₚᵣₑₛC dominates over 2×N×t_{d}, the f is primarily governed by the RC component. This allows us to approximate:

$$f \approx \frac{1}{2 π {R}_{pres} C}$$

At the unload state, resistance of the piezoresistive-based pressure sensor, Rₚᵣₑₛ, is about infinite. As the pressure applied, the resistance Rₚᵣₑₛ decreases, resulting the increase of the frequency. The degree of the applied pressure could be deduced by analyzing the frequency shift.

In addition, to prevent the subsequent stage from influencing the ring oscillator, another inverter is placed after the pulse generator before connecting the following component.

Next, the pulse width modulation unit 352 modulates width of a pulse signal based on the location of the corresponding sensor via an edge detector and a pulse width modulation RC circuit. The edge detector includes an inverter INV4 and an AND gate AG. The pulse width modulation RC circuit includes a pulse width modulation capacitor C_PW and a pulse width modulation resistor R_PW.

Specifically, the inverter INV4 has an input connected to an input of the pulse width modulation unit. The AND gate AG has a first input connected to the input of the inverter INV4 and an output connected to an output of the pulse width modulation unit. The capacitor C_PW has a first end connected to an output of the inverter INV4 and a second end connected to a ground GND. The resistor R_PW has a first end connected to the first end of the capacitor C_PW and a second end connected to a second input of the AND gate AG.

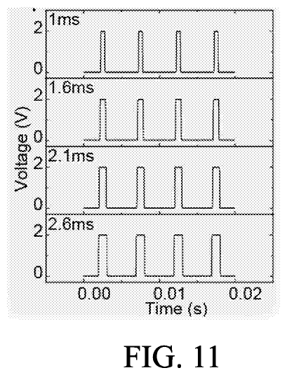

By adjusting the resistor R_PW (ranging from 1 kΩ to 7 kΩ), the charging time for the capacitor C_PW can be altered and the pulse width can be extended from 1 ms to 6.5 ms with discrete less than 0.03 ms in each point. In practice, pulse widths in a range from 1 ms to 2.6 ms are adopted for modulating the pulse signal (FIG. 11).

After the pulse width is set, the pulse shape modulation unit 353 further refines the pulse signal via a pulse shape modulation RC circuit. The pulse shape modulation RC circuit includes a pulse shape modulation resistor R_PS and a pulse shape modulation capacitor C_PS. The resistor R_PS has a first end connected to an input of the pulse shape modulation unit 353 and a second end connected to an output of the pulse shape modulation unit 353. The capacitor C_PS has a first end connected to the output of the pulse shape modulation unit 353 and a second end connected to a ground GND.

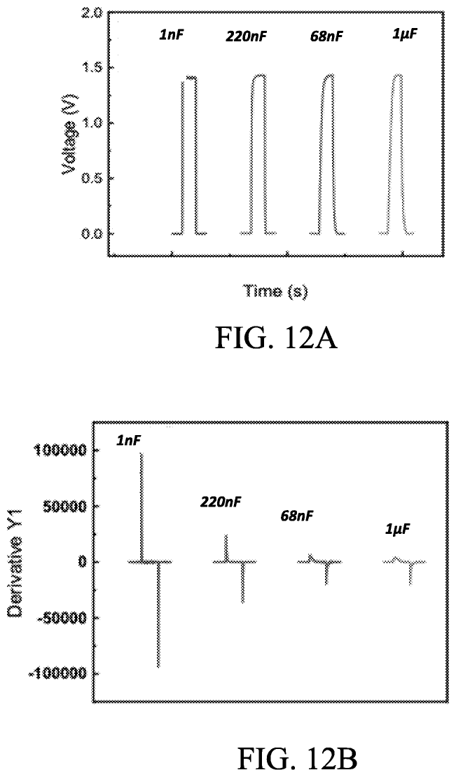

Changing the resistance R_PS in this unit 353 would cause a voltage drop that interferes with the amplitude modulation in next unit 354. To address this issue, the pulse shape modulation capacitance Cps is tuned instead to smooth the rising and falling edges. Larger capacitances of Cps produce more gradual edges, discernible by examining the maximum value of pulse's first-order derivative (FIGS. 12A and 12B).

Finally, the pulse amplitude modulation unit 354 further modulates amplitude of the pulse signal to perform last step of encoding. The pulse amplitude modulation unit 354 includes an amplitude modulation resistor R_AM, an inverting operational amplifier OpA and a feedback resistor R_f. The resistor R_AM has a first end connected to an input of the pulse amplitude modulation unit 354. The inverting operational amplifier OpA has a non-inverting input connected to a second end of the resistor R_AM; an inverting input connected to a ground GND; and an output connected to an output of the pulse amplitude modulation unit 354. The resistor R_f is connected between the non-inverting input and output of the amplifier OpA to form a feedback path.

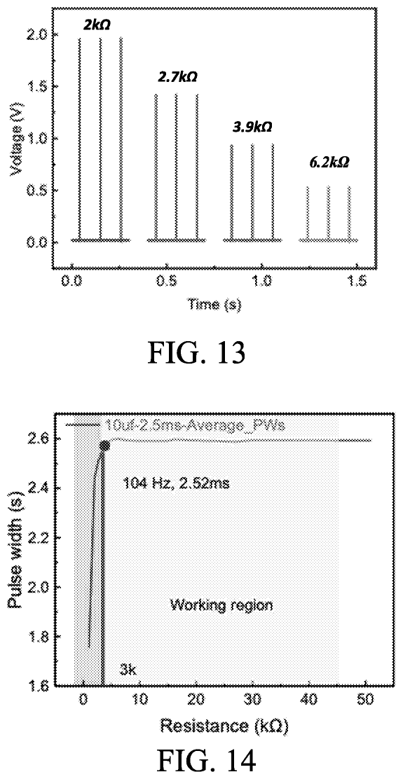

The inverting operational amplifier OpA adjusts the pulse amplitude based on:

$${V}_{out} = - \frac{{R}_{f}}{{R}_{AM}} \times {V}_{in}$$

where, Vₒᵤₜ is the output signal, R_{f} is the fixed feedback resistance (1 k) and R_{AM} is the amplitude modulation resistance. Varying R_{AM} changes the output amplitude (FIG. 13). In this design, amplitudes are selected in the range of 0.5 to 2V. The fully modulated signal is then fed into the signal integrator, combined with the output from other locations and delivered to the processing center.

After that, the processing center decodes the pulse signals to distinguish their features and infer their corresponding sensing channels, enabling precise tactile localization. Alternatively, the NRE-skin system also can perform rapid, approximate localization by analyzing only high-level features, such as pulse shapes, to infer their corresponding sensing areas.

The working ranges for the RC circuits used for pulse width and shape modulation are set to avoid pulse width and pulse shape modulating failure and confusion in pulse analyzing.

The pulse width modulation is realized by the edge detector and the pulse width modulation RC circuit. Charging to the pulse width modulation capacitor C_PW to the minimal trigger voltage takes time, and the time is the pulse width. Typically, setting a longer charging time would lead to a wider controlled (target) pulse width w_{c}. As the RC value is fixed, the pulse width should keep constant. However, the pulse width will be compressed under high pressure. FIG. 14 illustrates the relationship between the pulse width and the Rₚᵣₑₛ when the R_{PW} is kept at 3 kΩ. Typically, the pulse width should keep at around 2.5 ms under this circumstance. However, the curve shows an inflection point when the Rₚᵣₑₛ is around 2.7 kΩ, where the pulse width start decrease rapidly as the Rₚᵣₑₛ keep decreasing.

As the generated pulse is a standard square pulse with an original pulse width wₒ that is around half of the period (i.e. duty cycle=50%). When the pressure applied on the sensor is increasing, the increased pulse frequency would compress the original pulse width to wₒ. In the case the values of the original pulse width wₒ and target pulse width w_{c} are comparable, the target pulse width w_{c} would be out of control and causing the confusion in pulse analyzing.

In some embodiments, the maximum working frequency of the pulse generator is set at 100 Hz, and the maximum value of the pulse width modulation resistance R_{PW} is set to be 3 kΩ, so that the abovesaid out of control condition would only happen when the NRE-skin is pressed with extreme high pressure that causes the Rₚᵣₑₛ less than 3 kΩ. Moreover, to further prevent potential risk of the pulse width failure, a limiting resistor R_limit (e.g., 2.7 kΩ) may be added at the electrode in series with the sensor so that Rₚᵣₑₛ would also be kept above the inflection point.

In the pulse shape modulation layer (or unit), changes in pulse shape modulation capacitor C_PS affect the charging and discharging times, thereby shaping the pulse particularly by smoothing its rising and falling edges. However, if the RC time constant exceeds the pulse width, the pulse does not reach its intended amplitude before beginning to discharge, causing confusion in subsequent amplitude analysis. To prevent such situation, the maximum RC time constant must be designed remain below the shortest pulse width (1 ms in the current NRE-skin design).

When the pulse shape modulation capacitance C_PS exceeds 1 uF (with values ranging from 1 nF to 4.7 uF), the pulse fails this requirement, thus defining the upper limit for the capacitance C_PS.

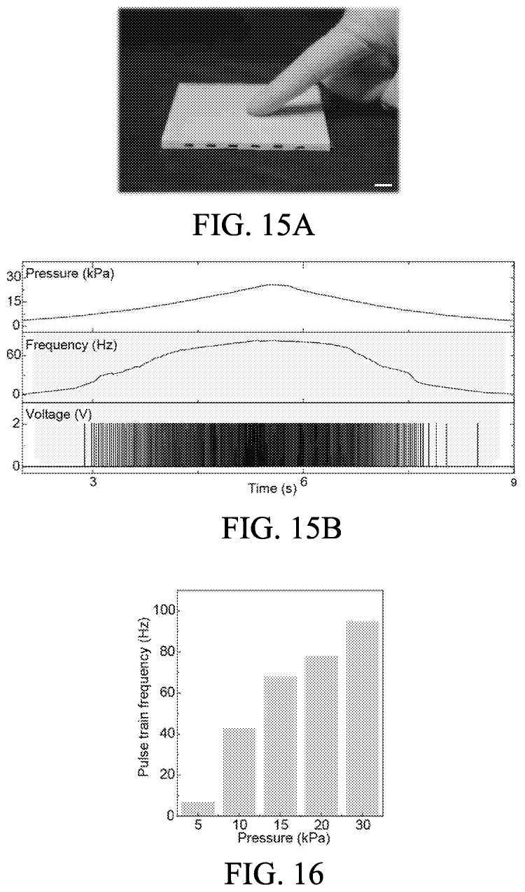

Moreover, the force degree applied on the NRE-skins can be represented by pulse frequency. As shown in FIGS. 15A and 15B, the gradually increasing and then releasing pressure leads to pulses that progress from low frequency to a peak frequency and then back to low frequency. The corresponding pulse frequency curve mirrors this trend. FIG. 16 further illustrates the relationship between applied pressure and the pulse frequency.

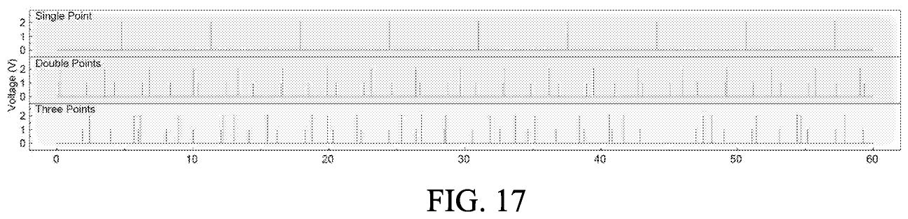

Moreover, the NRE-skin supports multi point tactile sensing. As depicted in FIG. 17, the three curves represent one, two and three points each produce a distinct response, accurately reflecting the combined pulse signals. Because this design uses only one output wire for the whole skin, it greatly reduces connection complexity and facilitates the expansion to multiple skins.

Pain and injury detection are the advanced functions of biological skin, crucial for protecting individuals by triggering immediate responses to prevent further harm. Despite their importance for enabling empathetic, human-centered interactions in robotics, few studies have explored these capabilities in artificial skins. To address this gap, the NRE-skin system is integrated with active pain and injury sensing, equipping robots with a protective, human-inspired sense of awareness.

In biological skin, specialized mechanical nociceptors would directly link to the local muscle on human body via the spinal cord central nervous system forming the local reflex arc. As long as the stimulus over the threshold, the pain signal will actively and directly trigger the muscle via the local arc to action body to protect himself from the danger. This is an unconscious reflex behavior, without any thinking from the brain, which is much faster.

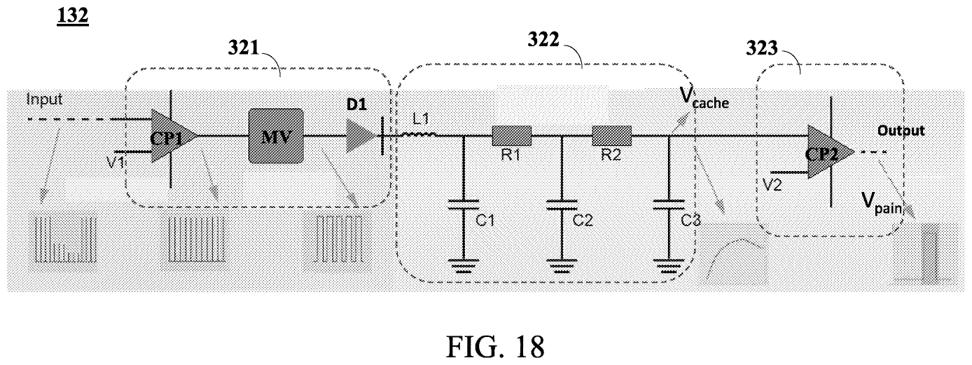

In order to emulate the pain reception of biological skin, in one embodiment, the pain center 132 of each NRE-skin includes an artificial pain receptor to detect extreme conditions. Referring to FIG. 18, the artificial pain receptor 132 consists of three main components: a pulse unification unit 321 configured to unify a merged pulse signal from the pulse generators in response to one or more stimuli, a signal cache unit 322 configured generated a cache voltage indicating strengths of the one or more stimuli, and a pain judgment unit 323 configured to judge (or determine) whether the strength reaches a predefined pain threshold and trigger a pain signal.

The pulse unification unit 321 is employed to address an issue of inconsistent charging rates for generating the cache voltage. The inconsistent charging rates, which are caused by the un-unified pulse properties (such as shape, width and amplitude) of raw input pulses, would disrupt the pain threshold criteria.

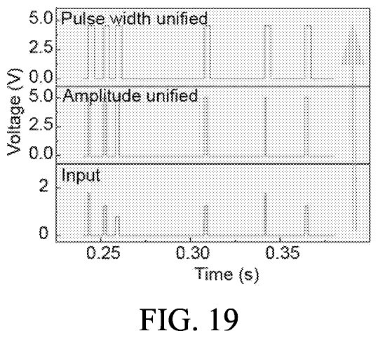

In one embodiment, the pulse unification unit 321 includes a comparator CP1 and a monostable multivibrator MV configured to standardize both pulse amplitude and width, and a diode D1. As a result, all pulses are unified with same properties (pulse amplitude of 5V and pulse width of 2 ms), ensuring a consistent charge rate under identical load conditions (FIG. 23 and FIGS. 19A and 19B).

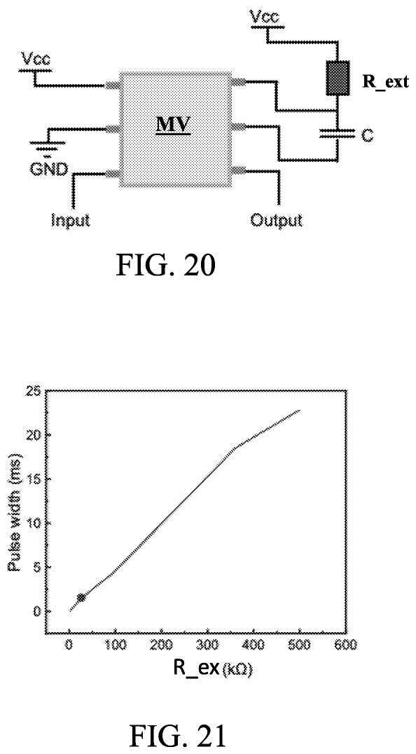

FIG. 20 illustrates more details of implementation of the monostable multivibrator MV. By adjusting an external resistor R_ex of the monostable multivibrator MV, the pulse width can be further tuned, thereby to refine the charging rate (FIG. 21).

The unified pulses are then transmitted to the signal cache unit 322. The signal cache unit 322 includes: a π-shape filter having an input connected to an input of the signal cache unit and an output connected to an output of the signal cache unit; and a capacitor C3 having a first end connected to the output of the signal cache unit and a second end connected to a ground GND. A charging voltage applied on the capacitor C3 acts as the cache voltage V_{cache} indicating the stimulus strength.

The π-shape filter consists of an inductor L1 having a first end connected to the input of the filter; a capacitor C1 having a first end connected to a second end of the inductor L1 and a second end connected to a ground GND; a resistor R1 having a first end connected to the second end of the inductor L1; a capacitor C2 having a first end connected to a second end of the resistor R1 and a second end connected to a ground GND; and a resistor R2 having a first end connected to the second end of the resistor R1 and a second end connected to the output of the filter.

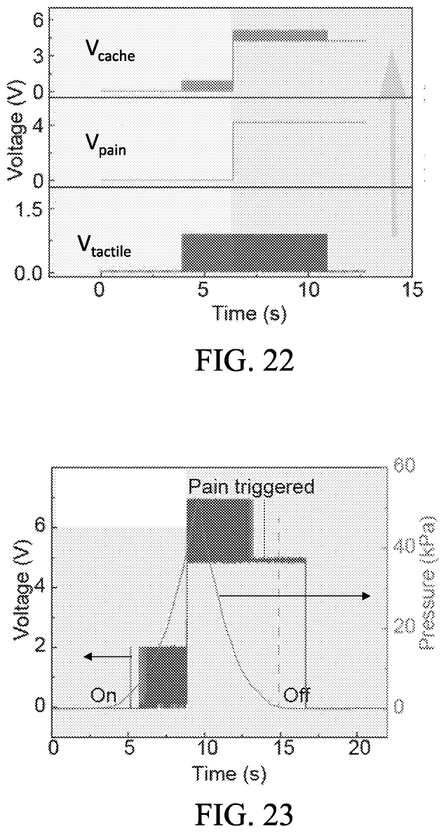

The pain judgment unit 323 comprises a comparator CP2 having a non-inverting input connected to the output of the signal cache unit and an inverting input connected to a reference voltage V2 (e.g. set at 3.9V). The comparator CP2 is configured to receive the cache voltage V_{cache} and compare the cache voltage V_{cache} against the reference voltage V2. Referring to FIG. 22, when the cache voltage surpasses the reference voltage V2, the second comparator outputs a 5V pain signal Vₚₐᵢₙ directly to the signal integrator. Because this 5V pain signal is both higher in priority and amplitude than normal tactile signals V_{tactile} (that is under 2V), it can quickly and directly trigger the interruption routine inside the local motor control center, initiating an immediate reflex action.

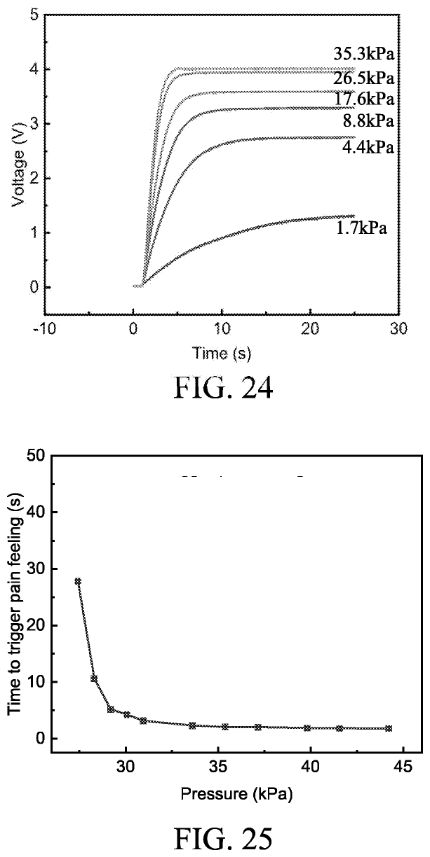

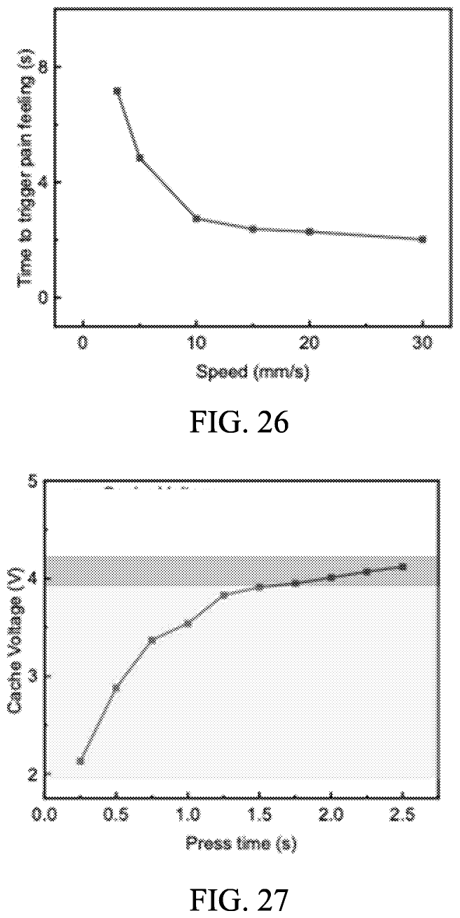

Moreover, the artificial pain receptors can simulate human skin perception. As pressure increases and crosses the pain threshold, pain is triggered. After releasing the pressure, the pain signal persists briefly before dissipating (FIG. 23). Varying pressure levels lead to distinct steady states, and only those at or above the threshold cache voltage initiate pain (FIG. 24). The time required to reach this state also varies, resulting in different pain onset times (FIG. 25). This behavior mirrors the biological skin system. People can endure heavy (but not extreme) pressure for a certain period before experiencing pain. Similarly, the speed and duration of applied pressure affect the timing of pain perception (FIG. 26 and FIG. 27). Even when the pressure surpasses the pain threshold, a delay occurs before pain is perceived, reflecting human-like sensory logic.

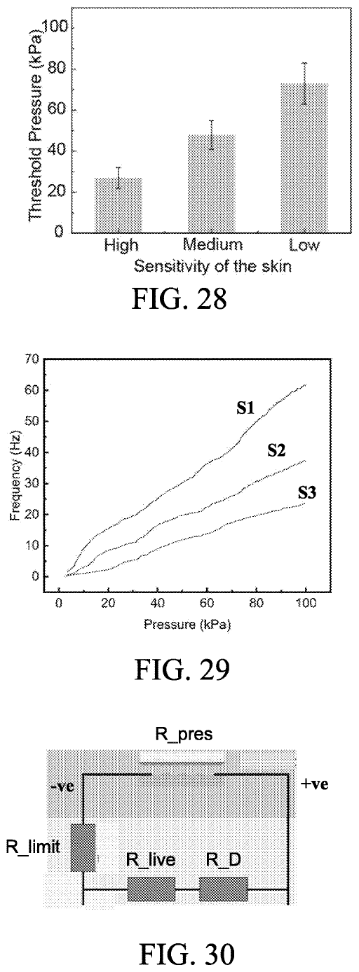

Moreover, pain sensitivity also depends on the underlying pressure sensor's performance of the NRE-skin. For example, a sensor with lower sensitivity produces a higher pain threshold (FIG. 28, FIG. 29). Consequently, the NRE-skin's sensitivity can be fine-tuned to be more sensitive in areas like the hands and less sensitive in regions like the back of a robot.

Human skin has a perfect reminder and repair mechanism to ensure that the human tactile perception system is in the best state. The skin can continuously send the stimulation position if the skin is injured to remind the people be careful and apply medicine. Therefore, it is also very important for robots to have similar capabilities to detect the state of the skin of being injured and ensure good sensing conditions.

To achieve the injury detection functionality, the pain center of the NRE-skin further includes an injury detection unit comprising a pair of live resistor R_live and differentiation resistor R_D connected in parallel with the piezoresistive pressure sensor R_pres; and a limiting resistor R_limit connected in series with the piezoresistive pressure sensor R_pres on one of the electrodes of the sensor (FIG. 30).

More specifically, the limiting resistor R_limit has a first end connected to one electrode of the pressure sensor R_pres, the live resistor R_live has a first end connected to a second end of the limiting resistor R_limit; and the differentiation resistor R_D has a first end connected to a second end of the resistor R_live and a second end connected to another electrode of the pressure sensor R_pres.

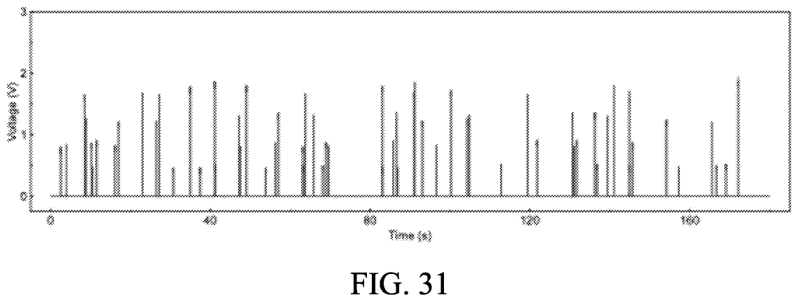

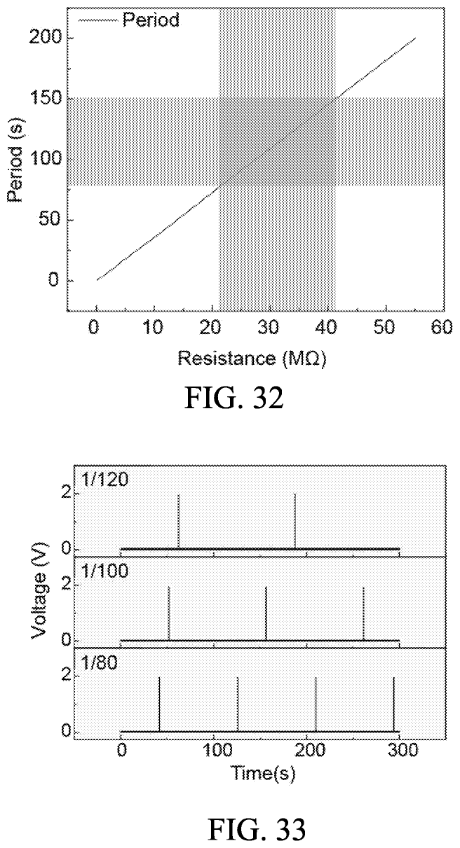

At the no-load state, the Rₚᵣₑₛ is almost infinite, and the parallel connected resistors R_live and R_D would control the charge time of the capacitor, which at the pulse generator and trigger the periodic live pulses (FIG. 31). Normally, the resistor R_live is around 22-40 MΩ (mainly for delay the charging time) and resistor R_D is around 500 k-10 MΩ (for differentiating the resistance of each pixels), so as to ensure that there will be a pulse periodically triggered with period longer than the period of pulse generator RC to about 75-150 s (FIGS. 32 and 33) and this is called as the live pulse.

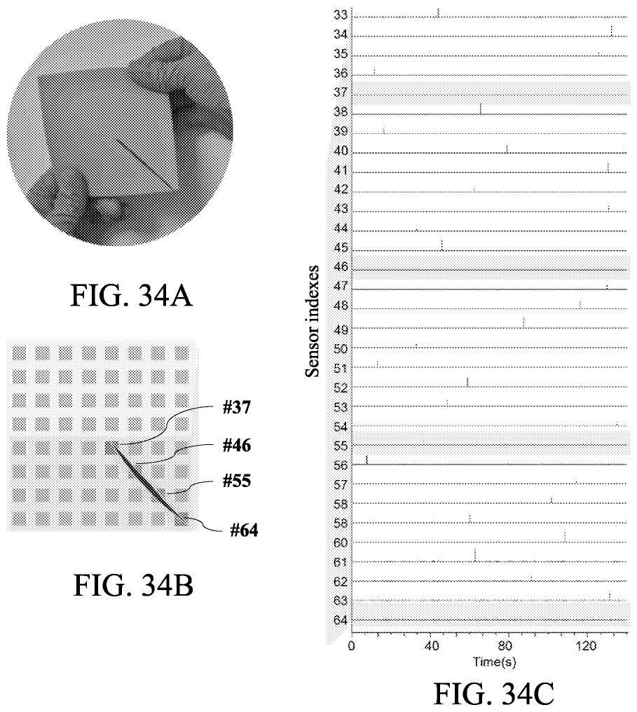

The limiting resistor R_limit is to prevent the pulse width failure. If the NRE-skin has been injured, the ring oscillator structure would break and cannot trigger any live pulse, dysfunction of this sensor. At the processing center, each sensor paired with a timer and the timer will reset as long as there is one live pulse been triggered. If a sensor failed to trigger a live pulse within 300 s, the timer overflows, marking the sensor as injured and continuously sending the injury signal to the interface. To demonstrate this functionality, the inventors cut the bottom right conner of the NRE-skin (FIGS. 34A and 34B) and monitored the live pulses from each pixel. As illustrated in FIG. 34C, those signals without live pulses are originated from sensors #37, #46, #55, #64 in the injured area, confirming the system's ability to accurately identify and signal injuries.

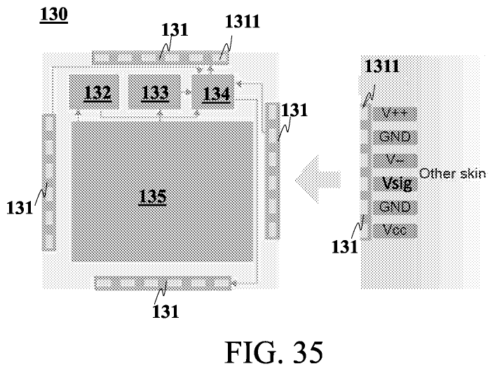

For a robot, the ability to rapidly replace damaged skin or switch skin to coverings with different sensitivity thresholds is critical for maintaining operational efficiency, adapting to changing environmental conditions, and ensuring the robot's ongoing functionality and longevity. In some embodiments, each connector 131 of the NRE-skin has a special magnetic quick interface constructed with a series of magnets 1311, which can achieve quick electrical connection of multiple NRE-skins through the specifically designed arrangement of magnets (FIG. 35).

Multi skins would connect with each other automatically when they are close together, with the magnets 1311 acting as both conductive wire and mechanical connectors. Each skin would serve as the neural relay to transmit signals from other skins to the final output of the processing center. To distinguish the different skins, every pulse signal would be superimposed with characteristic pulses to indicate its skin source.

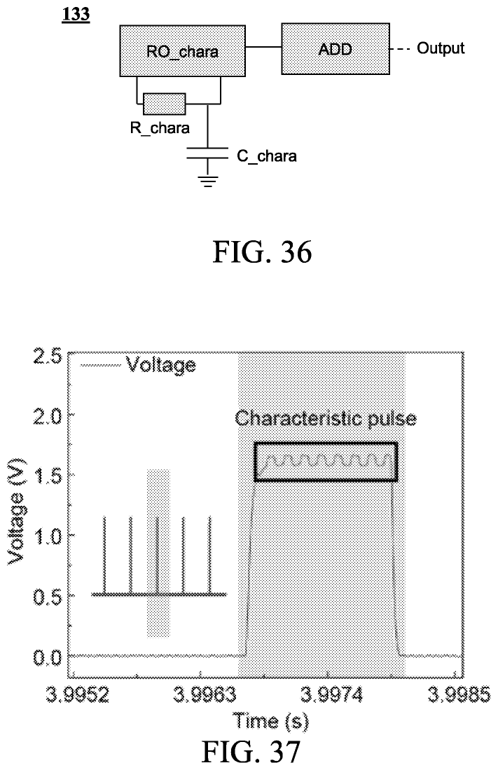

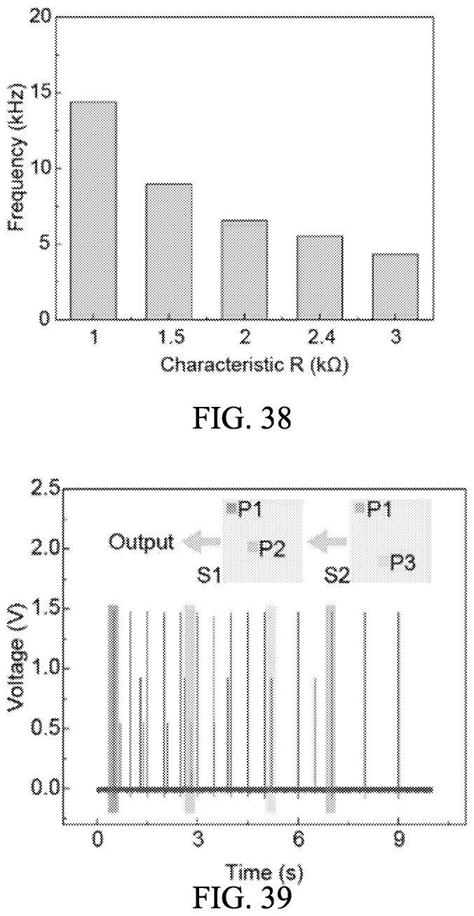

Specifically, each NRE-skin's label superimposing module 133 (or generator) comprises a ring oscillator RO_chara and a label superimposing RC circuit with a capacitor C_chara of capacitance ~100 nF and a characteristic resistance R_chara of a resistance in a range of 1-3 kΩ (FIG. 36). As such, the label superimposing module 133 can be configured to generate a specific high frequency peak and combine with the pressure pulses from the skin before output (FIG. 37) with a much higher label frequency (4-14 kHz) (FIG. 38).

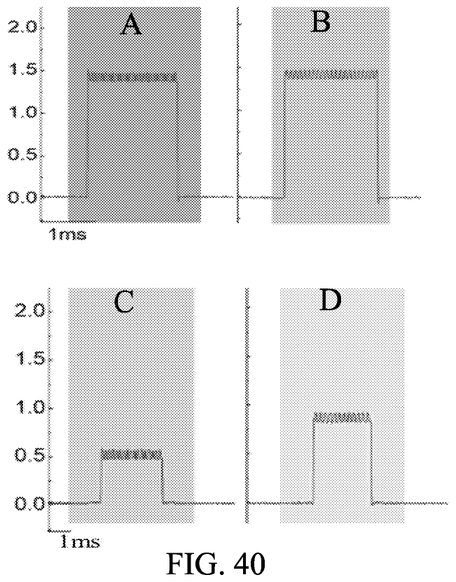

FIG. 39 shows signals transmitted from sensors in two adjacent connected skins S1 and S2 respectively. S1 has a characteristic resistance of 1.5 k and S2 has a characteristic resistance of 2 k. Referring to FIG. 40, signals A to D represent signals transmitted from a pixel P1 of skin S1, a pixel P1 of skin S2, a pixel P2 of skin S1 and a pixel P3 of skin S2 respectively to the processing center. That is, signals A and B demonstrate signals from the same place (pixel) in the two skins, while signals C and D demonstrate signals from two different places (pixels) in the two skins respectively. The stimuli applied at these places are all accurately detected, with pulses from S1 and S2 exhibiting distinct label peaks at the top edge. Notably, the peak label pulses (i.e., characteristic pulses) in S1 are significantly more intense (i.e. having higher peak frequency) than those in S2.

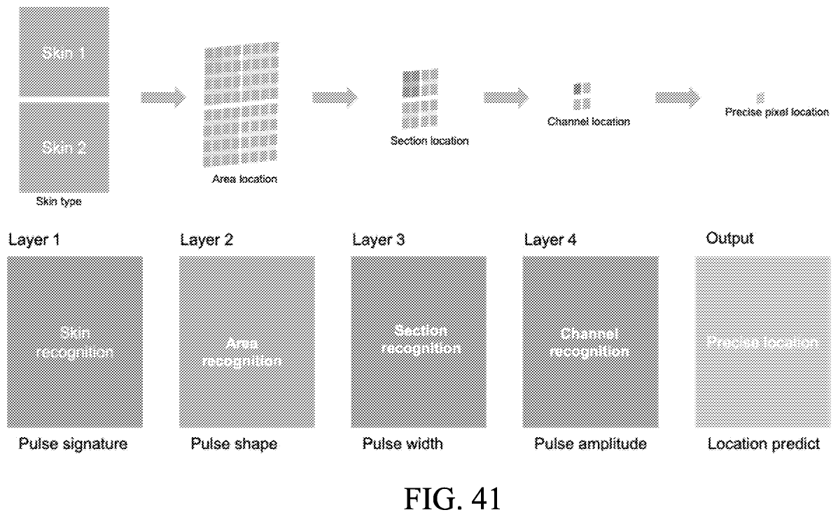

Similar to the physical network of the skin, a hierarchical recognition network is implemented in the processing center using machine learning to recognize the NRE skin that receives the stimulus and localize the stimulus from coarse position to precise position. The hierarchical recognition network includes a first layer for skin recognition, a second layer for area location, a third layer for section location and a fourth layer for channel location (FIG. 41).

The recognition process inversely mirrors the signal transmission logic, progressively narrowing from broad skin regions to specific channels. As mentioned above, the layered structure enables the NRE-skin system to perform rapid approximation localization and this method could enrich the dataset by grouping pixels with similar features. Finally, the integrated model realizes a recognition accuracy rate up to 99% by the Supporting Vector Machine (SVM) model.

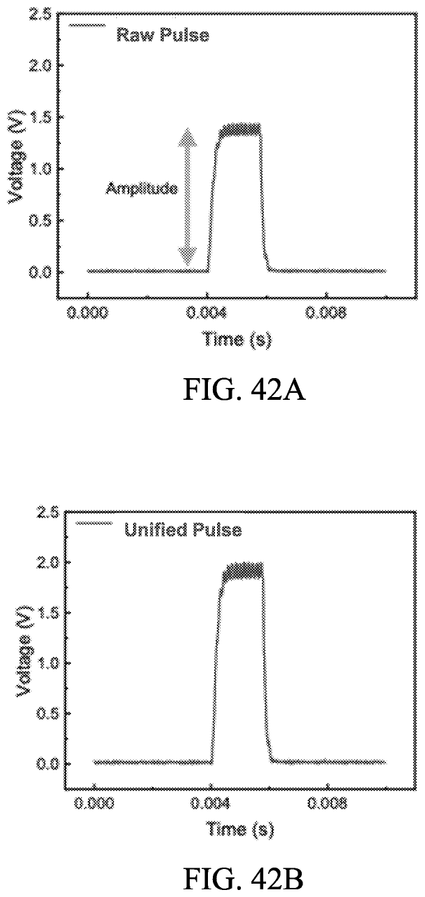

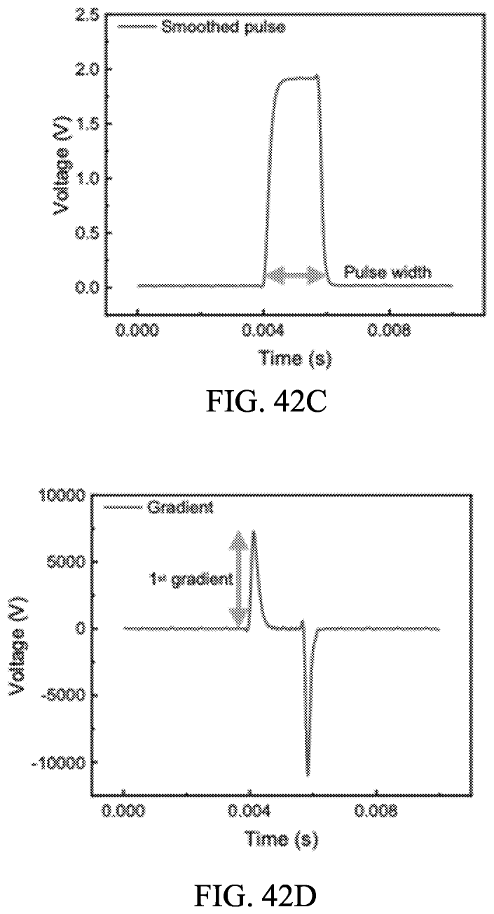

As shown in the diagrams in FIGS. 42A to 42D, the pulse recognition process consists of four primary steps. First, raw data are streamed in real-time to the processing center, from which only a raw core pulse (FIG. 42A) and its neighboring regions are selected for further analysis. Amplitude of the pulse is determined from the raw pulse. After isolating a single pulse, the model focuses on the peak region to extract the label frequency for skin-type classification. Next, the pulses are normalized to a uniform amplitude to obtain a unified pulse (FIG. 42B) from which width of the pulse is determined. Then peak high-frequency components are smoothed using one-dimensional convolution and the Savitzky-Golay filter to obtain a smoothed pulse (FIG. 42C), and finally a first order gradient of the pulse is obtained (FIG. 42D) to determine shape of the pulse. As such, the pulse shape, pulse width, and pulse amplitude of the pulse can be determined in a layer-by-layer manner.

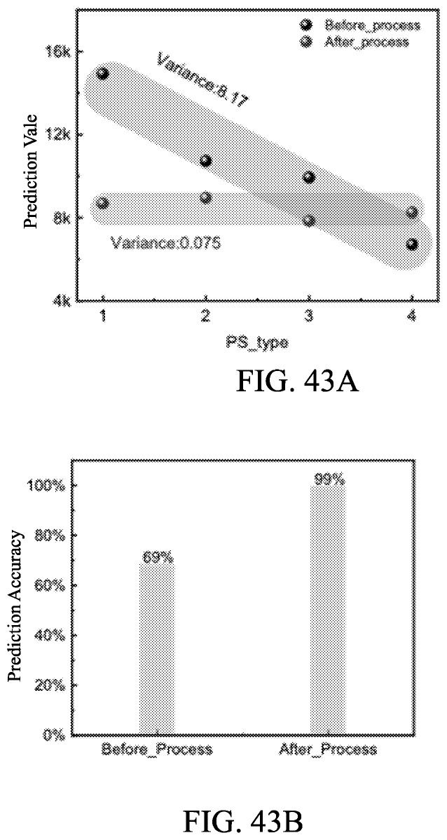

FIGS. 43A and 43B indicate that the unification process can reduce the first order gradient variance from 8.17 to 0.075 (FIG. 43A) and enhance the prediction accuracy from 69% to 99% (FIG. 43B).

Finally, by integrating these parameters, the precise pulse positions can be accurately identified. The prediction accuracies for each layer are approximately 100% for skin type, 99% for pulse shape, 98% for pulse width, and 99% for pulse amplitude.

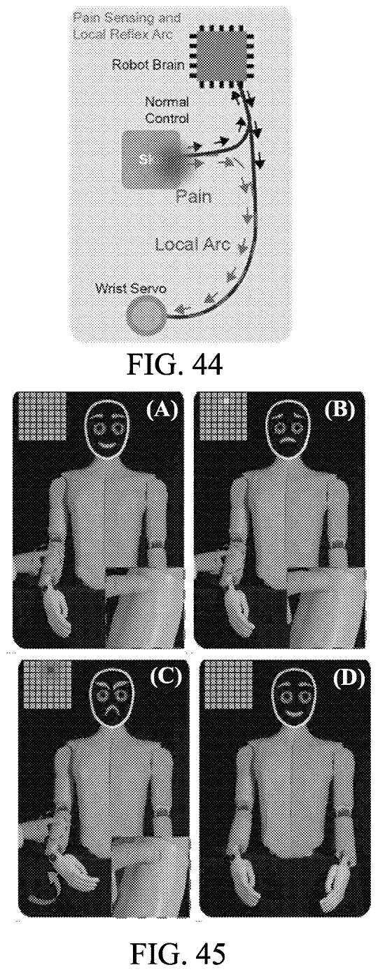

Furthermore, the NRE-skin is applied on a humanoid robot to show its advanced features including pain sensing with local reflection and active injury detection with fast replacement. Firstly, FIG. 44 elucidates the control logic for pressure perception and local reflexes, which mimics the human tactile perception and basic conditioned reflexes (the direct link between sensory neurons and motor neurons). When NRE-skin receives mild tactile stimuli, as shown in Image (A) of FIG. 45, the humanoid robot exhibits positive feedback, such as smiling expressions. As the pressure increases, the robot can perceive tactile information that is uncomfortable but tolerable, and accordingly produces mild negative feedback, such as displaying a distressed expression, as illustrated in Image (B) of FIG. 45. When the pressure escalates above the pain threshold, the robot experiences intense pain, and the pain signal would directly trigger the motor to move the hand to protect itself (this action is not judged by the processing center, the high-priority pain signal directly send to trigger the interruption action-wrist move), meanwhile the robot shows the painful expression (Image (C) of FIG. 45). This autonomous reflex mechanism closely mimics the conditioned reflexes of skin, where tactile receptors convert into pain signals upon exceeding a certain stimulation threshold, directly triggering an avoidance response through rapid control circuits within the skin (bypassing the main control unit, this is a much fast principle if there are thousands of such reflexes, and human people live with numerous these reflexes). Finally, Image (D) of FIG. 45 showcases the scenario where the humanoid robot returns to its stable state after all external stimuli are eliminated.

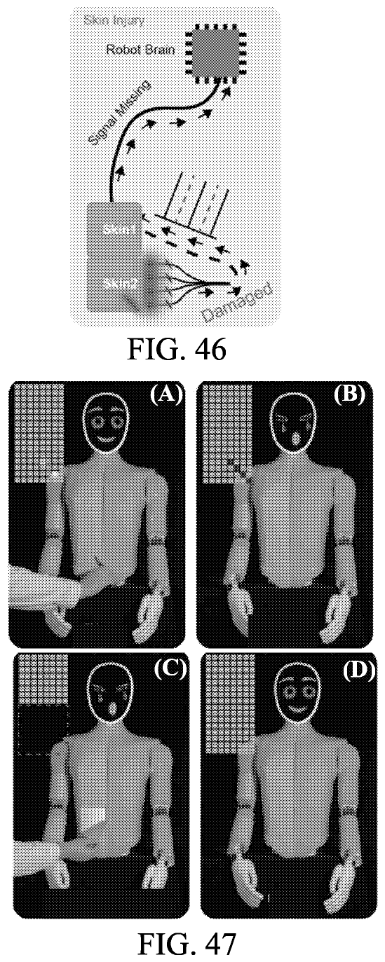

Human skin possesses remarkable self-repair capabilities, capable of autonomously growing and healing wounds. Therefore, as we mentioned before, because of the emphatic design and the nature of non-living organisms, electronic skin requires a different approach for robots to realize similar damage management. Consequently, the NRE-skin is designed to proactively detect and address injuries, bridging between biological self-healing and artificial constraints. Unlike previous electronic skins that required passive monitoring of wounds, the NRE-skin achieves autonomous injury detection through self-sensing technology, can realize the active whole-body sensing within every five minutes, as illustrated in FIG. 46. When the skin suffers irreversible damage, such as the cut wound shown in Image (A) of FIG. 47, this leads the missing live pulse from this location and inform the robot the injury of this skin (Image (B) of FIG. 47). Based on the fast assembly design concept of NRE-skin, the process of treating wounds becomes exceptionally simple-peel off the damaged NRE-skin (Image (C) of FIG. 47) and replace the intact NRE-skin (Image (D) of FIG. 47). Healthy skin would be online after the self-check.

The functional units and modules in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A neuromorphic robotic electronic (NRE) skin, comprising:
a substrate;
a circuit layer deposited on the substrate;
a sensing layer deposited on the circuit layer; and
a cover layer deposited on the sensing layer;
wherein the sensing layer includes an array of sensors, each configured for sensing a tactile stimulus applied on a corresponding location on the NRE skin and converting the sensed tactile stimulus to an electrical sensing signal; and
wherein the circuit layer includes:
a plurality of pulse generators, each configured to: receive an electrical sensing signal from a corresponding sensor in response to a tactile stimulus; and generate a pulse signal encoded with magnitude and location of the tactile stimulus;
a signal integrator module configured to combine the pulse signals generated by the plurality of pulse generators to produce an integrated pulse signal; and
a label superimposing module configured to superimpose a characteristic pulse signal on the integrated pulse signal to obtain a label pulse signal;
a pain receptor configured to trigger a pain signal when the tactile stimulus exceeds a pain threshold; and
a plurality of connectors configured to transmit the label pulse signal to a processing center or transmit the pain signal to a motion center.

2. The neuromorphic robotic electronic (NRE) skin according to claim 1, wherein each of the array of sensors includes a microstructured PDMS-based pressure sensor a coating of PEDOT:PSS.

3. The neuromorphic robotic electronic (NRE) skin according to claim 1, wherein the characteristic pulse signal has a specific frequency higher than frequencies of the pulse signals generated by the plurality of pulse generators.

4. The neuromorphic robotic electronic (NRE) skin according to claim 1, wherein the pulse generator includes:
a fundamental oscillation unit configured to generate a fundamental pulse signal having a frequency depending on the magnitude of the tactile stimulus; and
a hierarchical modulation network configured to modulate fundamental pulse signal to encode the location of the tactile stimulus to obtain an encoded pulse signal.

5. The neuromorphic robotic electronic (NRE) skin according to claim 1, wherein the hierarchical modulation network comprises:
a pulse shape unit configured to modulate a shape of the pulse signal to represent a location of the stimulus under a first spatial resolution;
a pulse width modulation unit configured to modulate a width of the pulse signal to represent the location of the stimulus under a second spatial resolution that is higher than the first spatial resolution; and
a pulse amplitude modulation unit configured to modulate an amplitude of the pulse signal to represent the location of the stimulus under a third spatial resolution that is higher than the second spatial resolution.

6. The neuromorphic robotic electronic (NRE) skin according to claim 1, wherein
the pain receptor comprising:
a pulse unification unit configured to unify amplitudes of pulses in the label pulse signal;
a signal cache unit configured generate a cache voltage proportional to frequency of the label pulse signal; and
a pain judgment unit configured to compare the cache voltage against a reference voltage and generate the pain signal when the cache voltage is higher than the reference voltage.

7. The neuromorphic robotic electronic (NRE) skin according to claim 1, wherein the circuit layer further comprises a plurality of injury detection units, each configured to induce live signal indicating whether the skin is damaged.

8. A neuromorphic robotic system, comprising a plurality of the neuromorphic robotic electronic (NRE) skins of claim 1, a processing center and a motion center;
wherein the processing center is configured to:
receive a plurality of label pulse signals from the plurality of NRE skins respectively; and
demodulate each label pulse signal to determine magnitude and position of a tactile stimulus associated with the label pulse signal; and
the motion center is configured to:
receive a plurality of pain signals from the plurality of NRE skins respectively; and
in response to each pain signal, drive one or more corresponding joint motors to form a reflex arc.

9. The neuromorphic robotic electronic (NRE) skin system according to claim 8, wherein each of the array of sensors includes a microstructured PDMS-based pressure sensor with a coating of PEDOT:PSS.

10. The neuromorphic robotic electronic (NRE) skin system according to claim 8, wherein the characteristic pulse signal has a specific frequency higher than frequencies of the pulse signals generated by the plurality of pulse generators.

11. The neuromorphic robotic electronic (NRE) skin system according to claim 8, wherein the pulse generator includes a fundamental oscillation unit configured to generate a fundamental pulse signal having a frequency depending on the magnitude of the tactile stimulus; and a hierarchical modulation network configured to modulate fundamental pulse signal to encode the location of the tactile stimulus to obtain an encoded pulse signal.

12. The neuromorphic robotic electronic (NRE) skin system according to claim 8, wherein the hierarchical modulation network comprises:
a pulse shape unit configured to modulate a shape of the pulse signal to represent a location of the tactile stimulus under a first spatial resolution;
a pulse width modulation unit configured to modulate a width of the pulse signal to represent the location of the tactile stimulus under a second spatial resolution that is higher than the first spatial resolution; and
a pulse amplitude modulation unit configured to modulate an amplitude of the pulse signal to represent the location of the tactile stimulus under a third spatial resolution that is higher than the second spatial resolution.

13. The neuromorphic robotic electronic (NRE) skin system according to claim 8, wherein the pain receptor comprising:
a pulse unification unit configured to unify amplitudes of pulses in the label pulse signal;
a signal cache unit configured generate a cache voltage proportional to frequency of the label pulse signal; and
a pain judgment unit configured to compare the cache voltage against a reference voltage and generate the pain signal when the cache voltage is higher than the reference voltage.

14. The neuromorphic robotic electronic (NRE) skin system according to claim 8, wherein the circuit layer further comprises a plurality of injury detection units, each configured to induce live signal indicating whether the skin is damaged.

15. The neuromorphic robotic electronic (NRE) skin system according to claim 12,
wherein the processing center is implemented with a hierarchical machine learning network including:
a first neural layer configured to demodulate the label of the pulse signal to identify the NRE skin receiving the tactile stimulus;
a second neural layer configured to demodulate the shape of the pulse signal to determine the location of the tactile stimulus under the first spatial resolution;
a third neural layer configured to demodulate the width of the pulse signal to determine the location of the tactile stimulus under the second spatial resolution; and
a fourth neural layer configured to demodulate the amplitude of the pulse signal to determine the location of the tactile stimulus under the third spatial resolution.
